(19) United States
(12) Patent Application Publication
(10) Pub. No.: US 2014/0052626 A1
(43) Pub. Date: Feb. 20, 2014

(54) SECURE EMAIL

(71) Applicant: Scayl, Inc., Woodland, WA (US)

(72) Inventors: Mark T. Mitchell, Menlo Park, CA (US); William R. Kallman, Woodland, WA (US); Donald L. Hoffman, Portland, OR (US)

(73) Assignee: Scayl, Inc., Woodland, WA (US)

(21) Appl. No.: 14/063,892

(22) Filed: Oct. 25, 2013

Related U.S. Application Data
(63) Continuation of application No. 12/507,741, filed on Jul. 22, 2009, now abandoned.
(60) Provisional application No. 61/082,715, filed on Jul. 22, 2008.

(51) Int. Cl. G06Q 20/10

(52) U.S. Cl. CPC G06Q 20/102
USPC 705/40

(57) ABSTRACT

Methods of paying debt over a network and debtor computer systems are provided for forming a secure email link between the debtor computer system and a creditor computer system; transmitting a notice of debt from the creditor computer system to the debtor computer system using the secure email link; and paying at least a portion of the debt at the debtor computer system based upon the notice of debt. The secure email link may be formed over a peer-to-peer email system.

### RELATED DISCLOSURES

This application is a continuation of U.S. patent application Ser. No. 12/507,741, filed Jul. 22, 2009 and entitled “SECURE EMAIL”, which application claims priority under 35 U.S.C. §119(e) to U.S. Provisional Patent Application No. 61/082,715 entitled “SECURE EMAIL”, which was filed on Jul. 22, 2008, both of which are incorporated herein by reference for all purposes.

### BACKGROUND

Existing email systems may be centrally controlled. Simple Mail Transport Protocol (“SMTP”) is the de facto standard used on the Internet today. A first SMTP server (e.g., mail.yin.com) may receive email messages from SMTP clients (e.g., Microsoft® Outlook, Mozilla® Thunderbird) executing on computers in the first SMTP server's domain. The email messages may include one or more recipient email addresses (e.g., john@yang.net). The first SMTP server may route the received messages to a second SMTP server on the intended recipient's domain (e.g., mail.yang.net) using known systems such as the domain name system (“DNS”). After receiving the email message, the second SMTP server may deliver the email messages to the intended recipient's mailbox, which may be stored on the second SMTP server and made available to the intended recipient over the network.

Unsolicited advertising emails (“SPAM”) are ubiquitous on the Internet. It is estimated by some that as of 2007, 90 billion SPAM messages are sent every day, and that so-called “abusive email” accounts for up to 85% of incoming mail in a given email inbox.

Electronic bill presentment and payment (“EBPP”) is the concept of replacing traditional paper bills sent to consumers with electronic bills that are presented to consumers via email or other similar means, so that consumers can initiate payment electronically. One of the main benefits of EBPP over traditional paper billing is the elimination of costs associated with printing and mailing bills.

However, the implementation of EPBB has been stymied for various reasons. Most bills sent to consumers via email require the consumer to log onto a third-party website to make a payment, requiring the consumer to remember a username and/or password. Entities wishing to send bills to consumers directly via email are reluctant to include potentially private information because the consumer email path through which consumers receive such bills is insecure (i.e., not encrypted). The consumer email path is also swarming with SPAM and phishing emails that consumers attempt to block using filters and other mechanisms. Sometimes these mechanisms prevent legitimate bills from reaching consumers.

### BRIEF DESCRIPTION OF THE DRAWINGS

FIG. 1 depicts an example email system.

FIGS. 2A-E depict an email transmission on a system where the sender and the intended recipient are both online simultaneously.

FIGS. 3A-H depict an email transmission on a system where the intended recipient is offline.

FIGS. 4A-C depict example methods of establishing and utilizing secure communication links to implement secure communications, such as EBPP.

### DETAILED DESCRIPTION OF VARIOUS EMBODIMENTS

A Peer-to-Peer (“P2P”) email system is provided for use by a plurality of users to exchange emails and attachments. An example of such a system is described in U.S. Patent Application Publication No. 2009/0144380, the disclosure of which is incorporated by reference for all purposes. Such a system may be controlled by one or more central servers, or it may be controlled by decentralized services distributed over a mesh network. Such a mesh network may comprise a plurality of node computers, each running a P2P email client according to the present disclosure. Node computers may be alternatively referred to as “peers.” Emails may be stored in mailboxes residing on each node, rather than centrally located. The system may encrypt emails during transmission, and the emails may remain encrypted while stored at each node computer.

In some embodiments, the system may be configured to allow the user of each node to establish a trusted relationship with one or more other nodes associated with one or more trusted entities so that the nodes may exchange secure email messages.

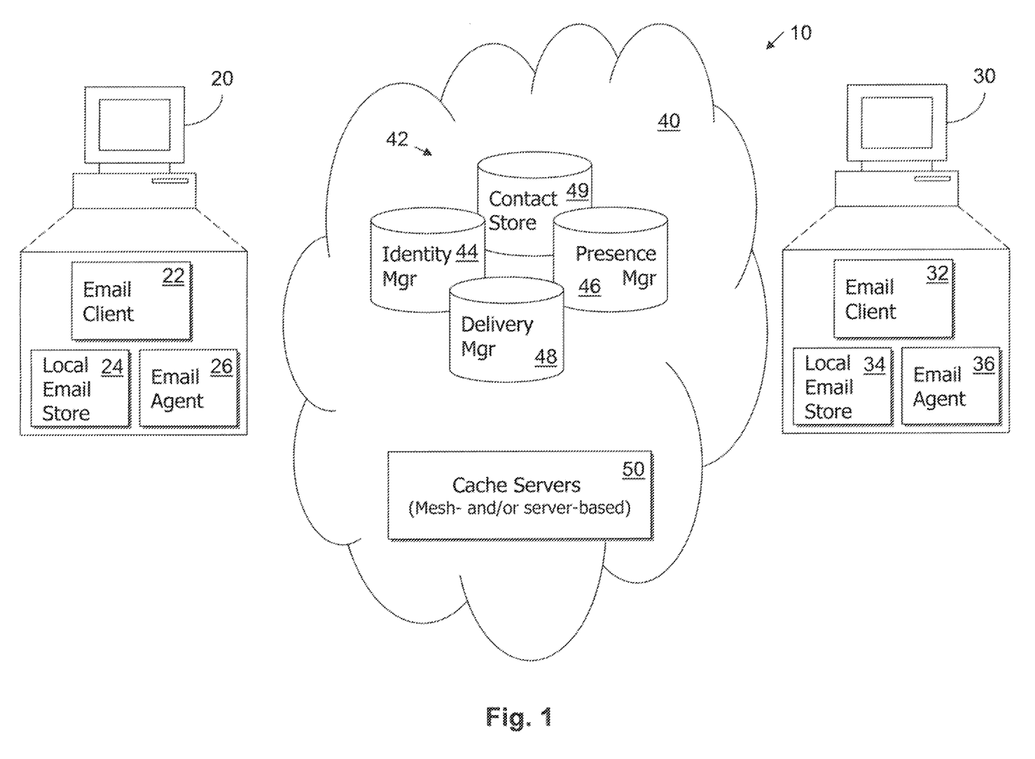

FIG. 1 depicts an example P2P email system 10 comprising node computers such as sender 20 and recipient 30. For this example, sender 20 may be a computer controlled by a first user intending to send an email message to a recipient 30. Recipient 30 likewise may be a computer controlled by a second user who is the intended recipient of the email message. Sender 20 and recipient 30 may be connected by a network 40. Sender 20 may include an email client 22, a local email store 24, and an email agent 26. Recipient 30 likewise may include an email client 32, a local email store 34, and an email agent 36.

Network 40 may be a local or wide-area computer network, including the Internet. The P2P email system 10 may be controlled by components on network 40, such as decentralized distributed services 42 including identity manager 44, presence manager 46, delivery manager 48, and contact store 49, as well as cache servers 50. The distributed services 42 will be described in further detail below. While decentralized distributed services 42 are shown having the four components 44, 46, 48 and 49 as being separate, these components may alternatively reside on a single server, and there may be more than one server hosting one or more of these services. Moreover, additional services which are not shown (e.g., a gateway server for sending emails to traditional email domains) may also be included.

Email clients 22 and 32 may include user interfaces resembling traditional email clients (e.g., Outlook, Thunderbird), and may be configured to allow a user to draft, send and receive P2P emails. Email clients 22 and 32 may further include interfaces allowing a user to select interests (e.g., kayaking, dating), which may be communicated to decentralized distributed services 42 so that potential advertisers may communicate solicited emails to clients 22 and 32, as will be discussed further below.

Local email stores 24 and 34 may be portions of memory (e.g., on a local hard drive) which may be used to store email messages and associated attachments. In other words, local email stores 24 and 34 may serve similar roles as mailboxes on traditional SMTP servers. Messages stored in local email stores 24 and 34 may be encrypted. The amount of space allocated to a user may be configured, and in some embodiments may be limited only by the computer's storage capabilities. In addition to emails and attachments, local mail stores 24 and 34 may store interest information (a.k.a. user metadata), user contacts (e.g., the user's friends residing on P2P email system and elsewhere), user profiles (e.g., photos available for viewing, whom may view the photos, personal information and to whom it is available), group membership (e.g., open or closed groups of users of P2P email system 10 having common interests/metadata/contacts) or the like. Interest information, contacts, profiles and other similar information may be configured by a user using email clients such as 22 or 32.

Email agents 26 and 36 may be processes executing on node computers such as sender 20 or recipient 30 forming the P2P network. While a computer such as sender 20 or recipient 30 is connected to network 40 and is executing its email agent (26 or 36), that computer may be considered ‘online’ for purposes of the P2P network and this discussion.

Contact store 49 may be a central server or servers, or it may be a service distributed among various nodes in the P2P email system 10. It may contain information allowing peers on P2P email system 10 to locate other peers, including information similar to that stored in local email stores described above like interest information, contacts, metadata, group membership, and the like. Peers may be searched at contact store 49 using various search values, such as interests, group membership, friendship networks, personal profiles, and the like. In some embodiments, users may synchronize information stored in their local email stores 24, 34 such as metadata, profiles, and contacts with information contained in contact store 49. In other embodiments where contact store 49 is a service distributed among various nodes, there may be a central contact store (not shown) which is configured to synchronize all nodes on which contact store 49 is contained.

Cache servers 50 may comprise one or more computers on network 40 which may be used as intermediate points in email communications between computers such as sender 20 and recipient 30. Cache servers 50 may be configured to cache at least a portion of email messages, as well as attachments thereto. In some embodiments, each cache server may be a node computer, similar to sender 20 or receiver 30, forming another peer on the P2P system. Additionally or alternatively, cache servers 50 may be specialized computers maintained specifically for the purpose of caching emails. In some embodiments, cache servers may only cache attachments having a size smaller than a predetermined size (e.g., <50 Megabytes).

A given email message in transition between sender 20 and recipient 30 may be stored at a number of cache servers 50 while awaiting delivery, providing redundancy and high availability of the email message to recipient 30 in case some of the cache servers become unavailable (e.g., go offline). Moreover, cache servers 50, which may simply be peers or node computers on P2P system 10, may be configured to forward email messages to other intermediate peers closer to the recipient's destination. Additionally or alternatively, if a given cache server is going to go offline, it may forward copies of its stored pending email messages/attachments and/or notify the P2P email system of the email's new location.

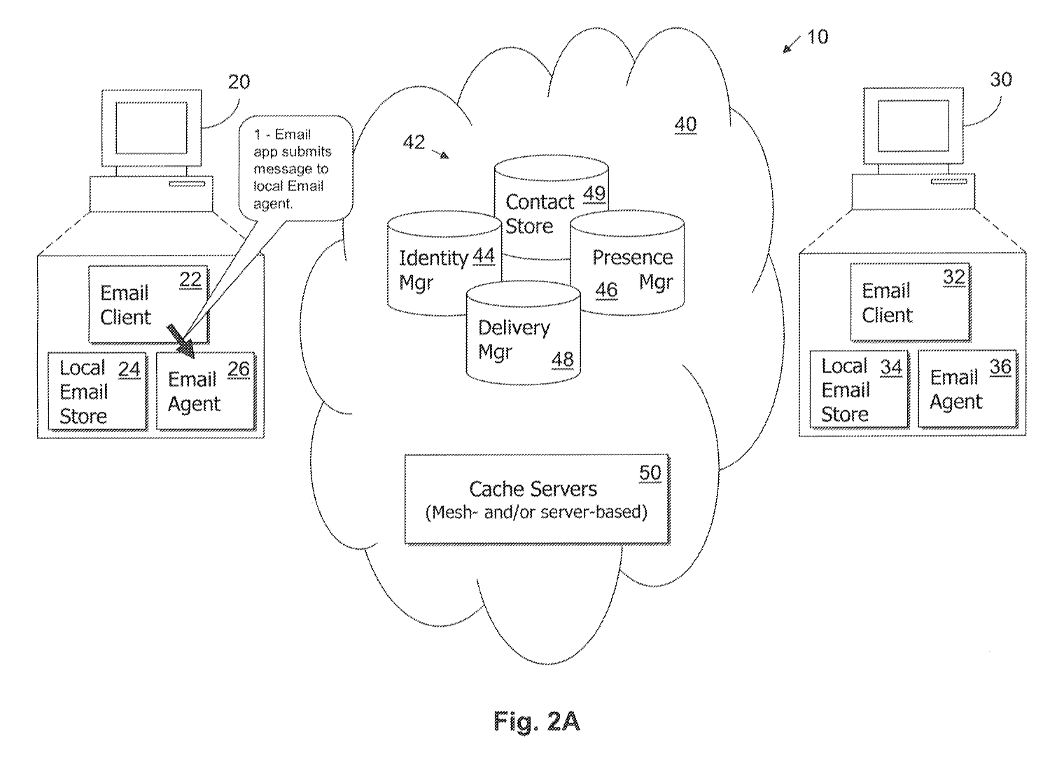

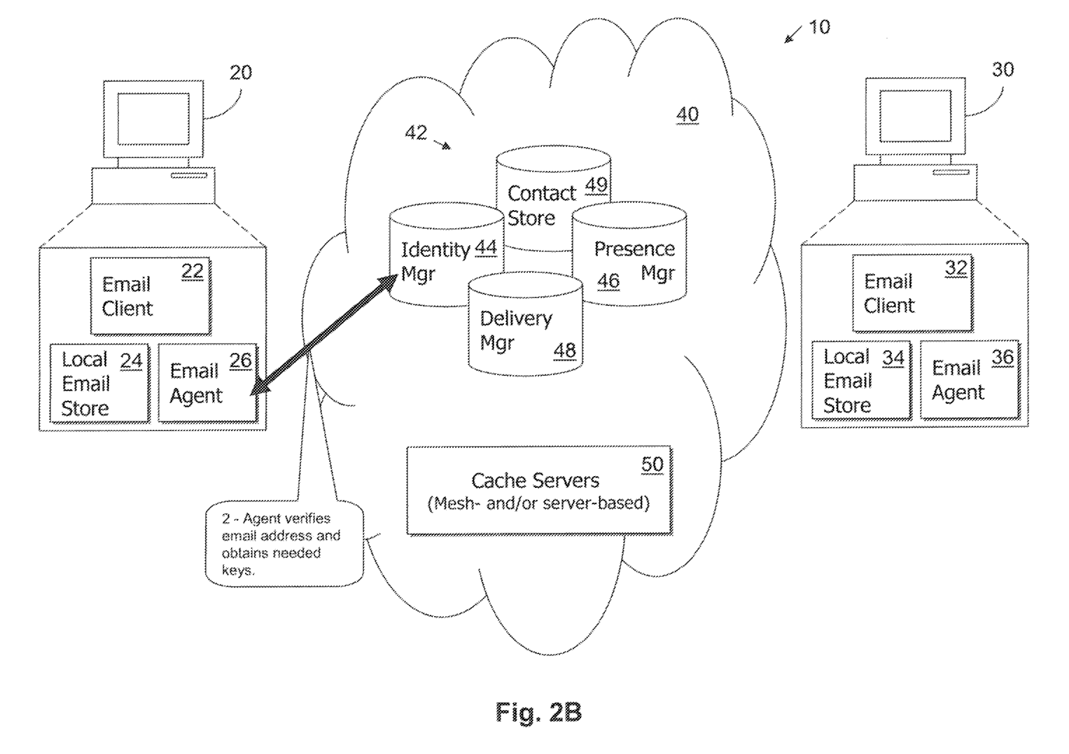

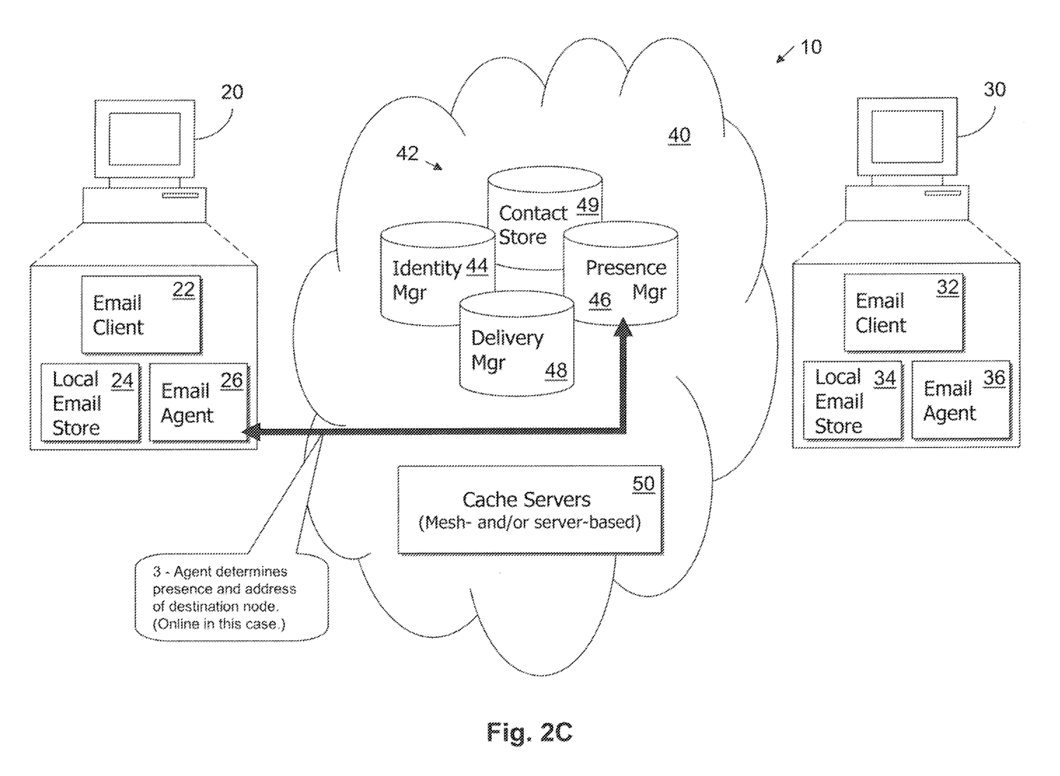

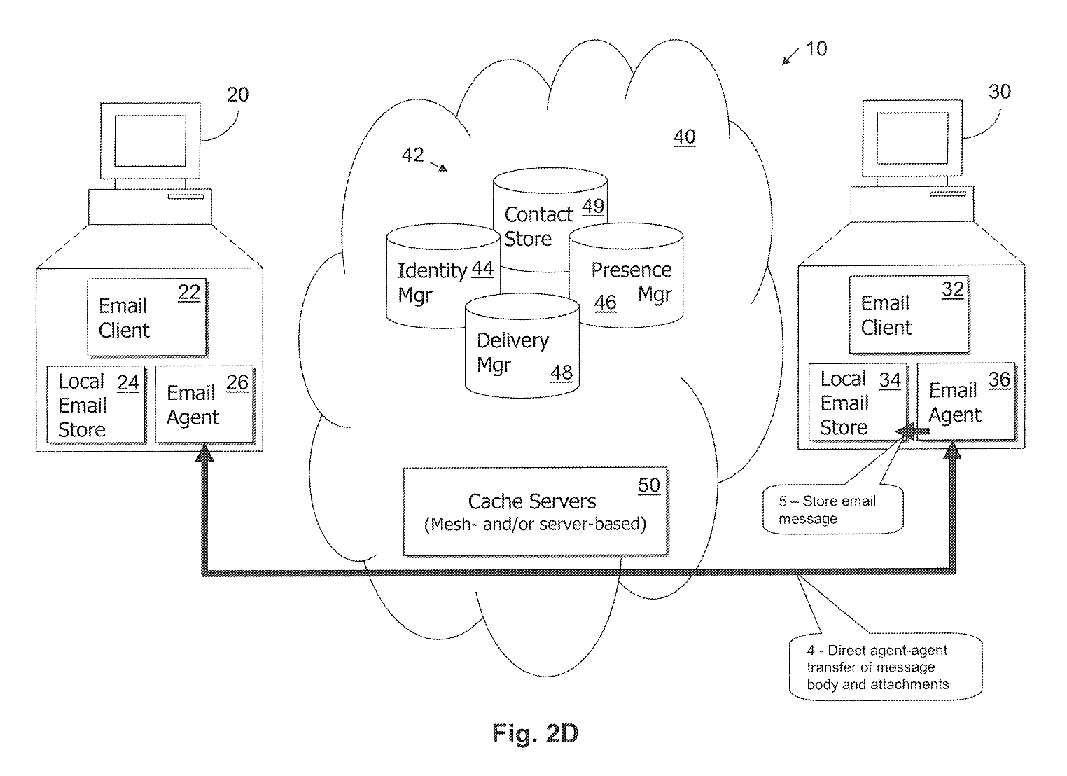

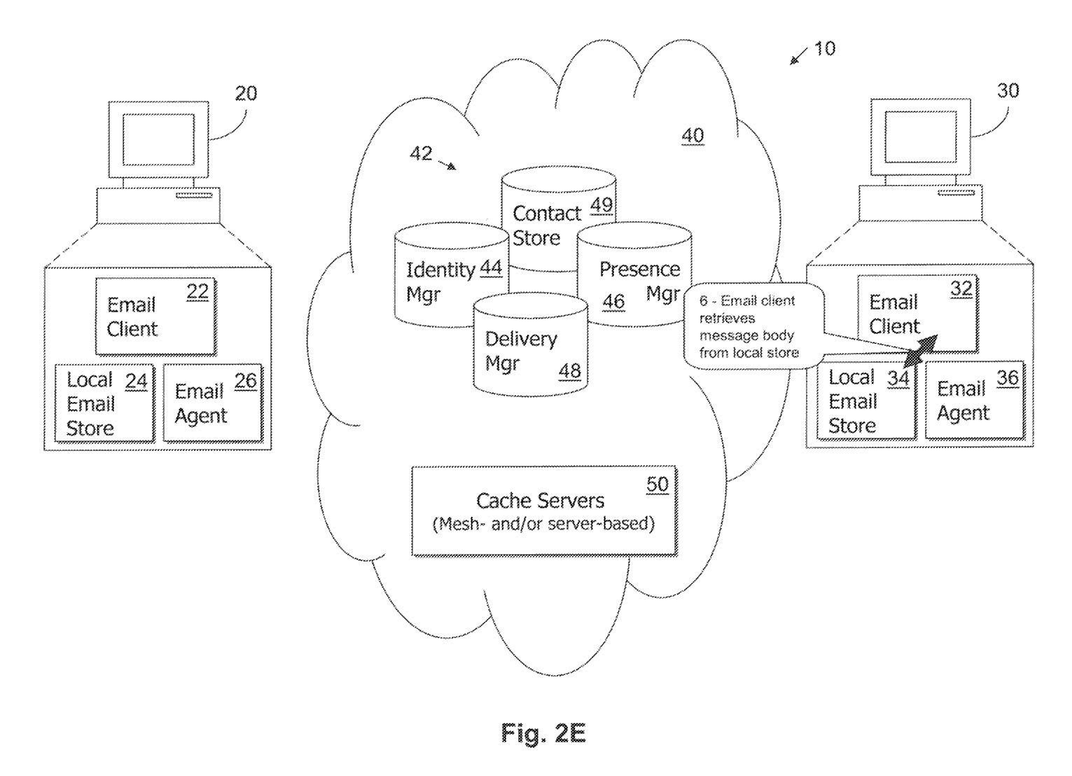

The P2P email system 10 will now be explained by example. An example email communication between two node computers 20 and 30, which are online simultaneously, is shown in FIGS. 2A-E. In step 1 of FIG. 2A, email client application 22 submits an email message created by a first user to email agent 26. In step 2 of FIG. 2B, email agent 26 communicates with identity manager 44 to verify the recipient email address(es) contained in the email message, and to obtain one or more public keys corresponding to the verified email address(es). The public keys may be used by email agent 26 to encrypt the email message and/or any the message's attachments.

Identity manager 44 may take various forms. In some embodiments, identity manager 44 may be a central database running a hash table or similar data structure for relating email addresses to public keys. In other embodiments, identity manager 44 may be a distributed hash table (“DHT”), such as Content Addressable Network (“CAN”), Chord, Kademlia, Pastry, P-Grid, Tapestry or NeoNet, to name a few. DHTs are a class of decentralized distributed systems that provide a lookup service similar to a hash table. They are well-known in the art, and therefore need not be described further here. Email addresses such as the recipient email address may comprise the names of the hash table, and the value(s) corresponding to each name may be one or more public keys. Email agents such as 36 each may possess private keys usable to decrypt messages encrypted with the one or more public keys.

In step 3 of FIG. 2C, sender email agent 26 may communicate with presence manager 46 to determine whether recipient 30 is online. If recipient 30 is online, sender email agent 26 may obtain recipient's network address (e.g., IP address).

Presence manager 46 may be a central server configured to track the presence of email clients and make that information available to email agents such as 26 and 36. Presence manager may be a central server or decentralized service, implementing various protocols, such as the Extensible Messaging and Presence Protocol (“XMPP”), for real-time or near-real-time presence information. Jabber Instant Messaging and Presence technology is based on XMPP, and may be used in some embodiments as presence manager 46.

Once sender email agent 26 has obtained the network address of recipient 30 from presence manager 46, sender email agent 26 may transmit the email message and any attachments thereto directly to recipient email agent 36 in step 4 of FIG. 2D. When recipient email agent 36 receives the email message, in step 5 of FIG. 2D, it may store the email message (which may remain encrypted) and attachments thereto in local email store 34.

When the user of recipient 30 executes email client 32 to check her email, in step 6 of FIG. 2E, recipient email client 32 may communicate with local email store 34 to obtain all recipient's email messages, including the newest message just received, as well as any attachments thereto. If the messages are encrypted, email client 32 may use its private key, corresponding to the public key described above, to decrypt messages.

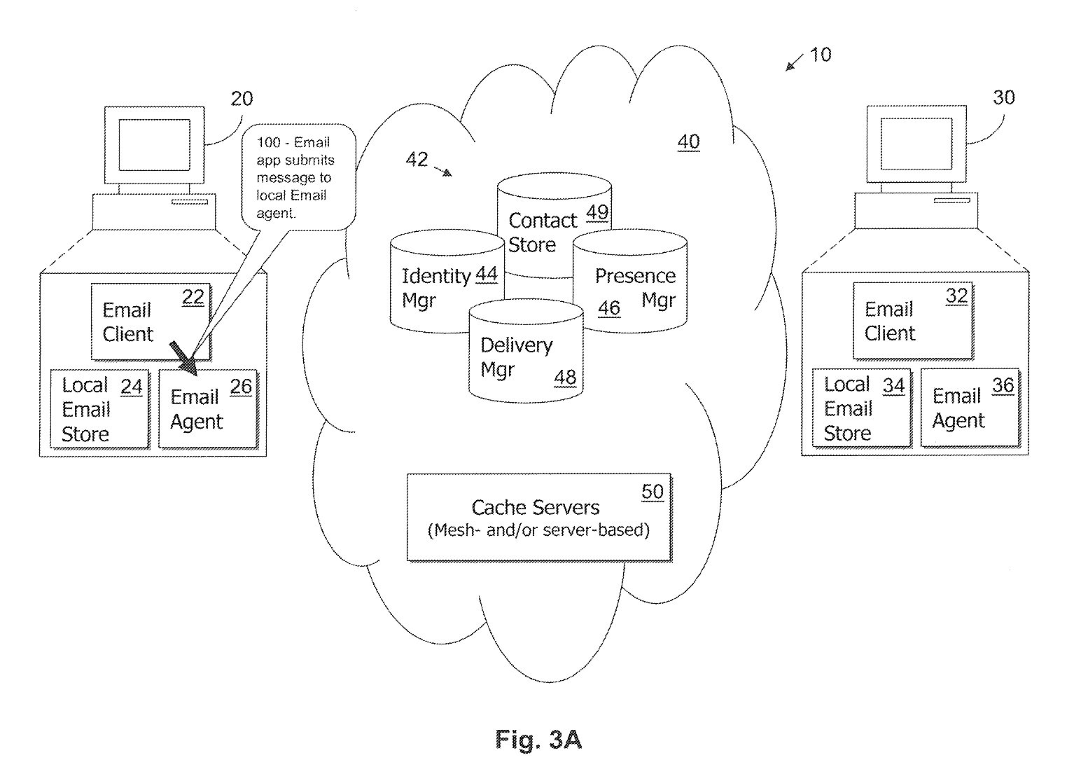

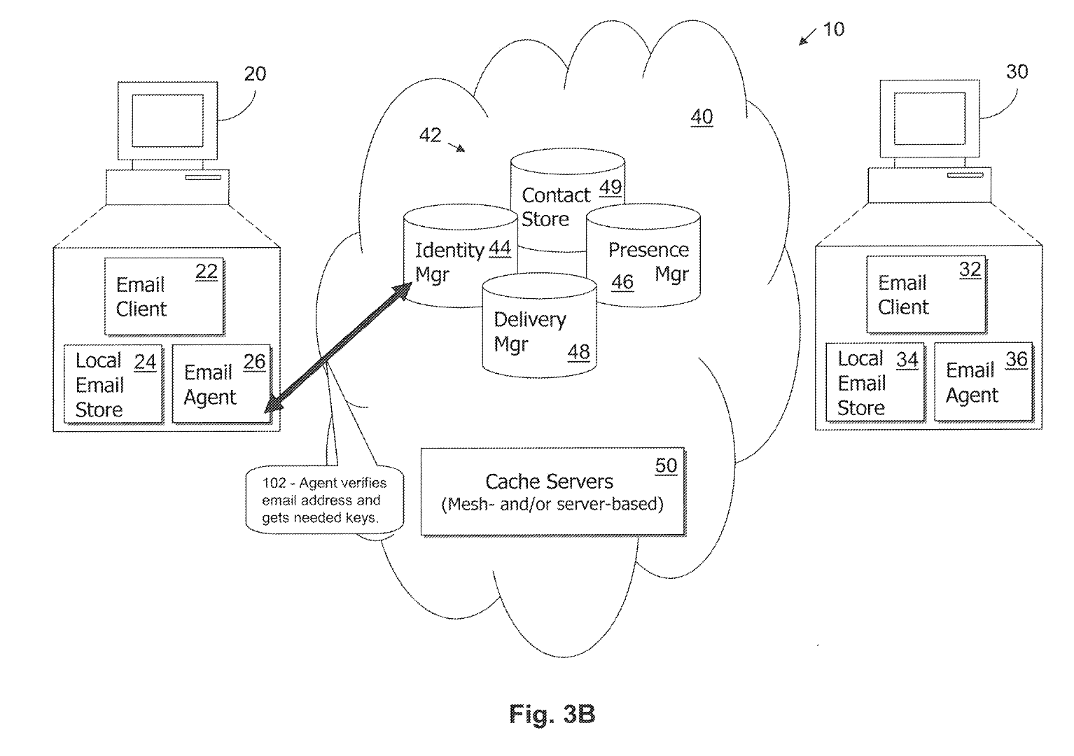

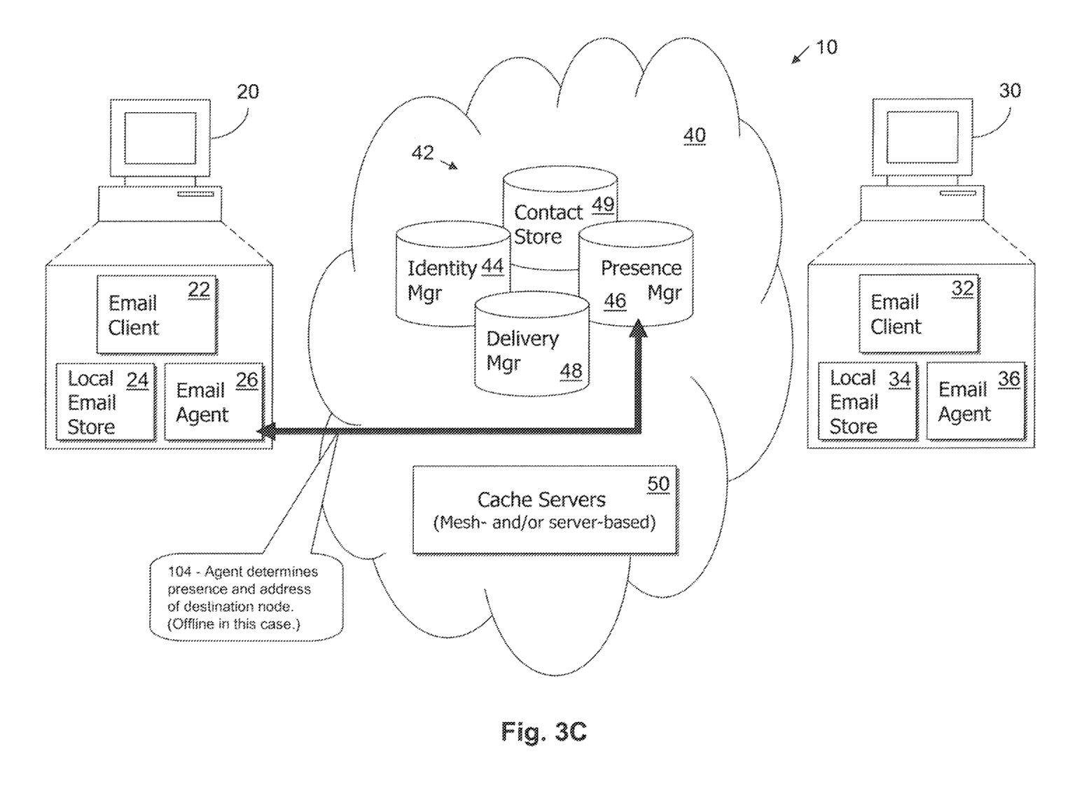

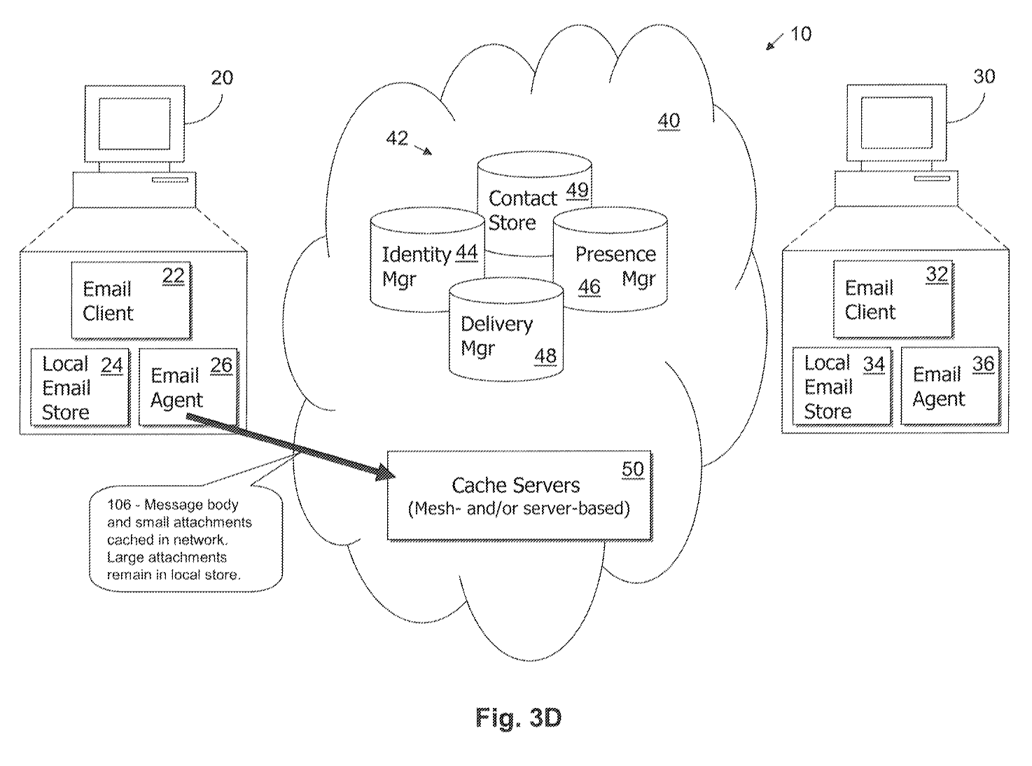

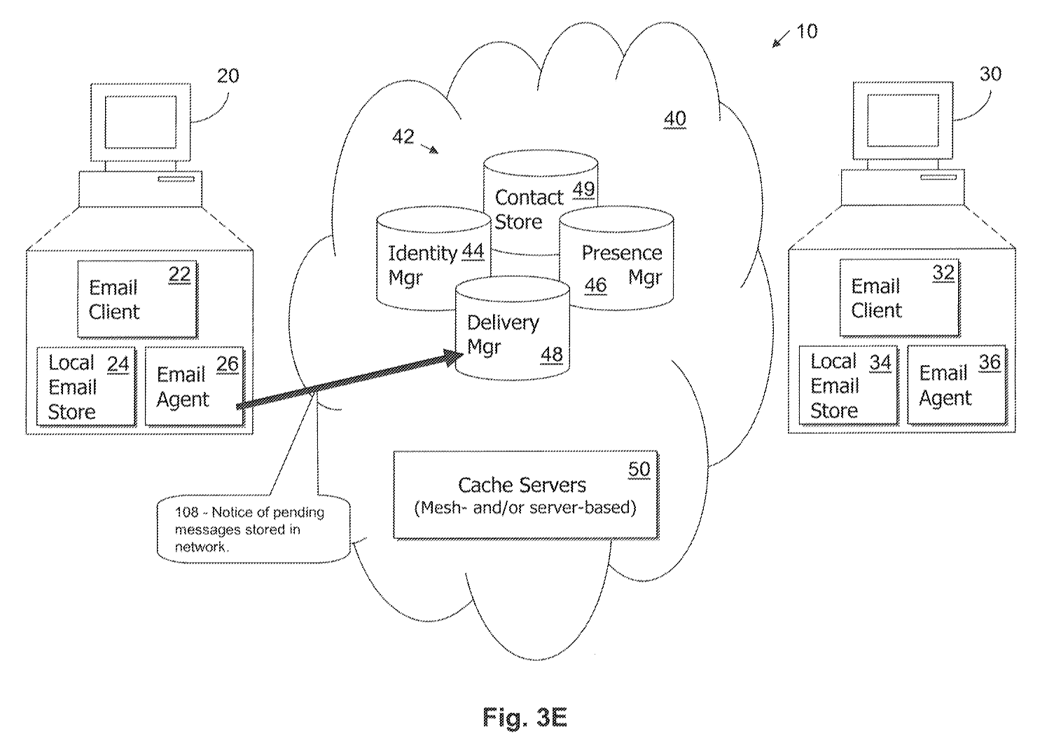

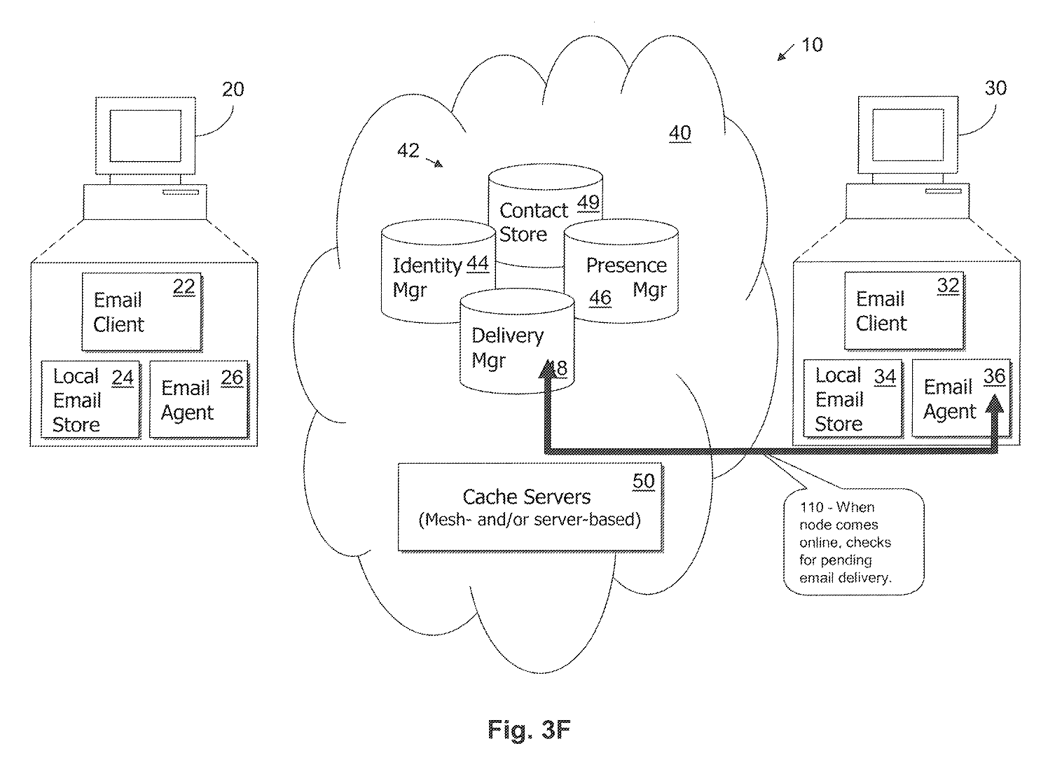

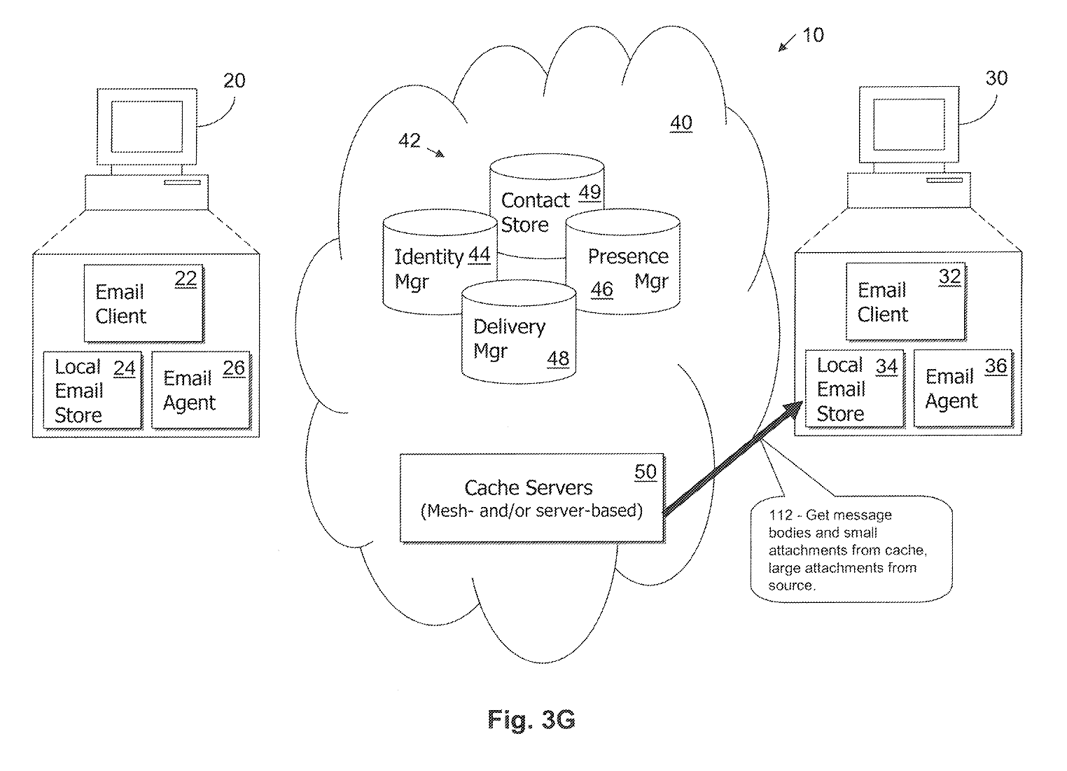

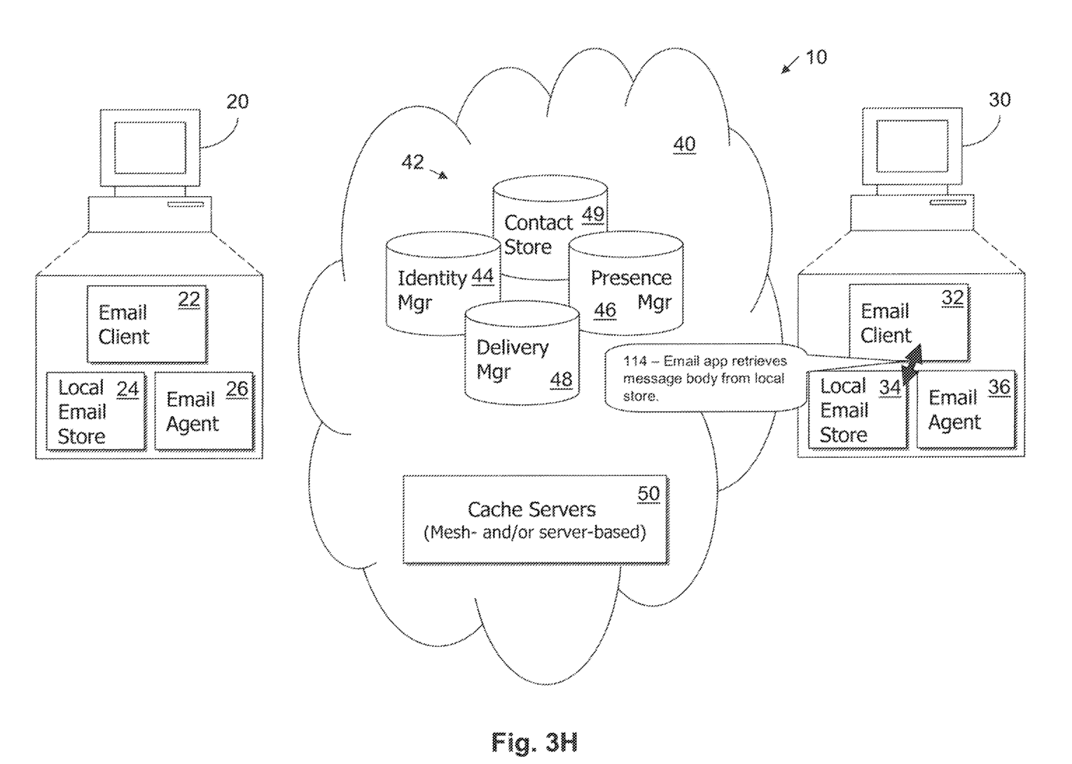

The above discussion describes an email transmission where both sender 20 and recipient 30 are online simultaneously. However, there is no guarantee that recipient 30 will be online at the moment sender 30 transmits an email message. FIGS. 3A-H and the following discussion describe one possible way an email may be transmitted between sender 20 and recipient 30 under such a scenario.

In step 100 shown in FIG. 3A, similar to step 1 of FIG. 2A, email client application 22 submits an email message created by a user to email agent 26. Similar to step 2 in FIG. 2B, in step 102 of FIG. 3B, email agent 26 connects to identity manager 44 to verify the recipient email addresses contained in the email message, and to obtain public keys corresponding to the verified email addresses. And again, in step 104 in FIG. 3C, sender email agent 26 communicates with presence manager 46 to determine whether recipient 30 is online.

In the previous example, recipient 30 was online, and therefore available to receive the email message and attachments directly from sender 20. However, in this example, recipient 30 is offline. Therefore, in step 106 of FIG. 3D, sender email agent 24 may communicate the message body of the email message and any attachments having a size less than a predetermined amount to cache servers 50 residing on network 40. In some embodiments, attachments having sizes greater than the predetermined amount may remain stored locally on sender 20. In step 108 of FIG. 3E, sender email agent 26 may notify delivery manager 48 that there are pending messages stored in network 40, as well as where those pending message may be located (e.g., on which cache servers 50 the message is cached).

In some embodiments, delivery manager 48 may be a central server configured to store information regarding pending P2P email messages stored in network 40. In other embodiments, delivery manager 48 may be a decentralized service such as a DHT or other similar distributed systems.

In some embodiments where delivery manager 48 is a DHT, the names may be recipient email addresses, and the values associated therewith may include information necessary for recipient email agent 36 to obtain pending email messages from network 40. Such information may include address information associated with particular cache servers 50 having cached copies of the pending email. The address information may be a network address of the particular cache servers 50 storing the pending emails, or, if each cache server is merely another node similar to 20 or 30, the address information may be an email address associated with each node.

In other embodiments, each email message or attachment may have a unique Universal Resource Name (“URN”). Recipient email agent 36 may be notified of any URNs associated with email messages or attachments destined for recipient 30. A delivery manager 48 implementing a DHT may use URNs related to pending email messages and attachments as names, and the value(s) associated with each URN may be a Universal Resource Locator (“URL”). The URL may indicate where the email message/attachment identified by a URN may be found, as well as what method may be used to obtain the message/attachment (e.g, ftp://www.yin.com/attachment.jpg indicates that the file ‘attachment.jpg’ may be obtained from the domain yin.com using the ftp protocol).

Accordingly, when recipient 30 comes online, in step 110 of FIG. 3F, recipient email agent 36 may communicate with delivery manager 48 to determine whether there are pending email messages on network 40 which are intended for recipient 30 and to identify one or more cache servers 50 where those messages are located. In some embodiments, recipient email agent 36 may next communicate with presence manager 44 to determine which of the identified nodes are currently online and those nodes' network addresses.

Next, in step 112 of FIG. 3G, recipient local email store 34 (or alternatively, recipient email agent 36) may communicate with the identified nodes of the cache servers 50 to retrieve message bodies and attachments having a size less than the predetermined amount described above.

Attachments larger than the predetermined size may be obtained from the original sender 30, assuming sender 30 is currently online. If sender 20 is not currently online, recipient 30 may periodically query presence manager 46 so that when sender 20 comes back online, recipient 30 may then obtain the large attachment directly from sender 20.

In some embodiments, where local email store 34 or email agent 36 must download multiple emails from cache servers 50, it may prioritize which emails/attachments will be retrieved first. For instance, an email client 32 may provide an interface for a user to edit contacts and sort them by various criterion (e.g., degrees of separation of friendship, age, etc.). Using this priority information, email client 32 or agent 36 may retrieve emails/attachments in the order of which its contacts have been sorted by the user. This priority information may be synchronized with contact store 49 when convenient.

When the user of recipient device wishes to read the received message(s), he or she may use recipient email client 32 to view email messages, including newly received messages, stored in local email store 34 in step 108 of FIG. 3H.

In some embodiments, sender 20 may be configured to verify that recipient 30 received or took action with respect to the email. For instance, recipient email agent 36 may send an acknowledgement to sender 20 once recipient local email store 34 has received and stored the entirety of the email and any attachments thereto. Additionally or alternatively, Sender 20 may query recipient 30 to determine whether recipient 30 received the message. Additionally or alternatively, Sender 20 may query recipient 30 to determine whether recipient 30 opened the message. In some embodiments, recipient 30 may notify one of the services in decentralized distributed services 42 (e.g., delivery manager 48) that a message having a particular URN has been delivered. In such a case, sender 20 may verify that the message was received and/or opened by communicating with the services 42.

In the P2P email system disclosed herein, some embodiments may be configured to prevent unsolicited email and/or provide a mechanism for a first peer to establish a secure email link with another peer (hereafter referred to as a “trusted entity”), such as a billing entity (e.g., cable company), another user (e.g., a partner in a business), a government agency (e.g., the IRS), and the like. A secure email link is accomplished by encrypting emails as provided by the above-described P2P email system, authenticating received emails, and/or storing authenticated emails in secure locations of memory in local email stores. In some examples, secure email links as described herein may be used to implement EBPP in a secure manner that circumvents the problem of users filtering out legitimate bills as SPAM.

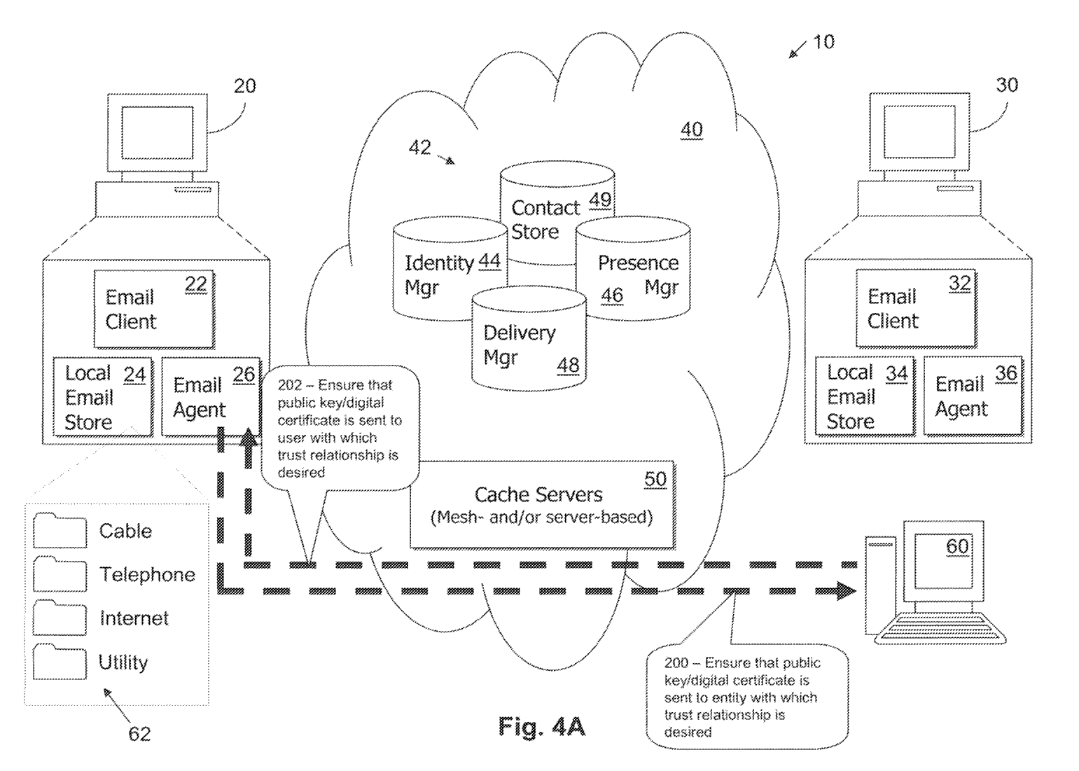

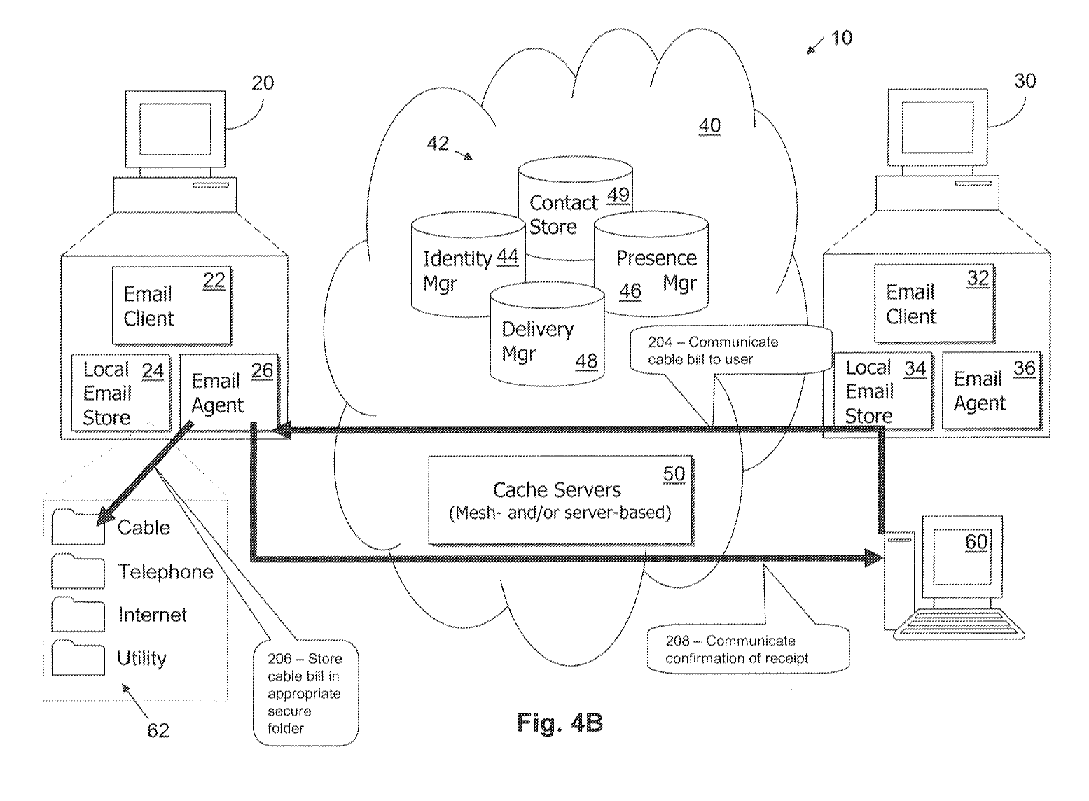

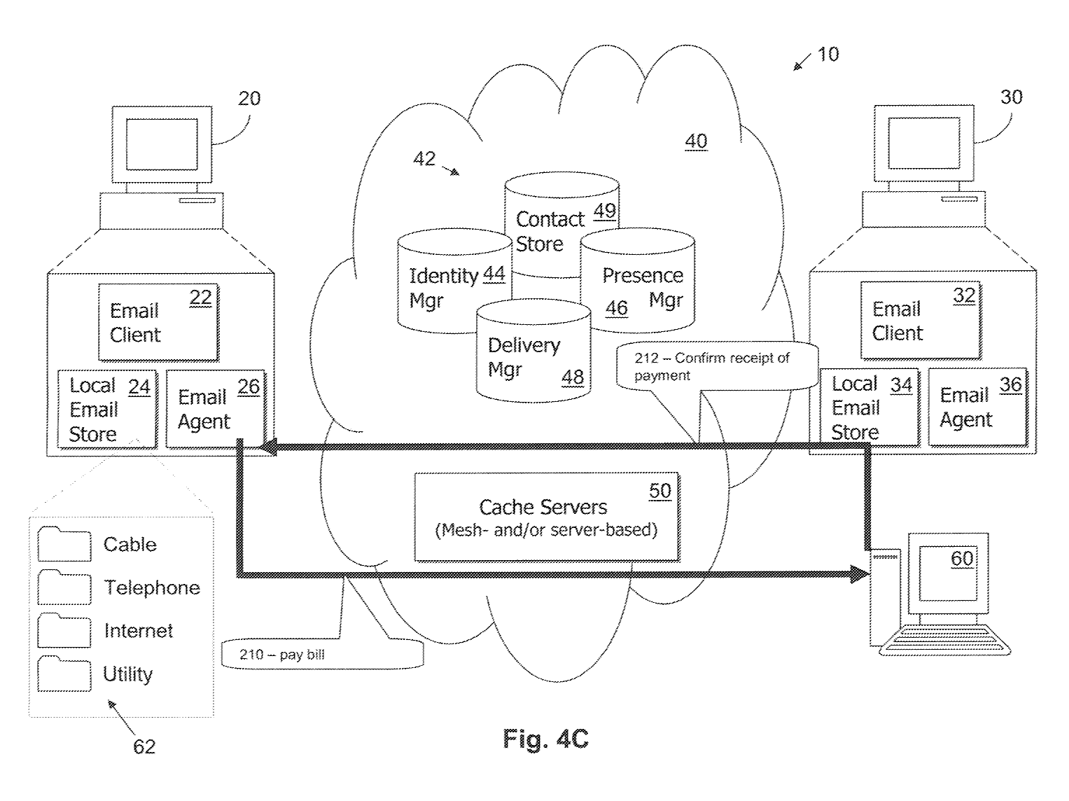

FIG. 4A depicts an example of a debtor computer system 20, also referred to as peer 20 (although referred to as “sender” in previous Figs., it should be understood that debtor computer system 20 merely is one of a plurality of peers on P2P email system 10), establishing a secure email link with a trusted entity 60, which may in some cases be a creditor computer system run by a party to which a user of debtor computer system 20 owes a debt. In step 200, debtor computer system 20 ensures that trusted entity 60 receives a public key, digital certificate and/or other security mechanisms that allow trusted entity 60 and user 20 to communicate securely. Likewise, in step 202, trusted entity 60 ensures that user 20 receives a public key, digital certificate and/or other security mechanisms that allow secure communications between peer 20 and trusted entity 60.

Steps 200 and 202 are shown in dotted lines because they may be accomplished in various ways. In some embodiments, a user of debtor computer system 20 may establish a relationship with a creditor that uses creditor computer system 60 outside of the context of the P2P email system. For example, a consumer (debtor) purchases a car from a dealership (creditor), and during the transaction, the consumer provides her P2P email address to the dealership. The dealership may then obtain the public key associated with the consumer's P2P email address from identity manager 44, as described in step 2 of FIG. 2B, above. Public keys may also be exchanged directly over the network (e.g., FTP) or by computer media (e.g., CD-ROM, DVD) distributed through the mail. It should be understood that steps 202 and 204 may take place in a different order than described above.

Local email store 24 may be configured with one or more secure portions of memory, or folders 62, for storing messages to and/or from trusted entities over secure communication channels. For example, one secure folder may be created to store messages to/from a cable company, and another secure folder may be created to store messages to/from a telephone company. Secure folders 62 may be secured using encryption or other similar means. Emails stored within secure folders may not be accessible without a proper local credential, such as a username and/or password. Accordingly, if a laptop computer having an email store on its hard drive is lost or stolen, emails contained within secure folders may be inaccessible. In some embodiments, a single set of credentials may be usable to obtain access to all secure folders in an email store and/or from trusted entities over secure communication channels.

Assuming now that trusted entity 60 is a creditor computer system 60 (run, for instance, but a cable provider). Creditor computer system 60 may transmit a notice of debt (e.g., a monthly cable bill) to debtor computer system 20 in step 204 of FIG. 4B. Although shown as a plain line from creditor computer system 60 to debtor computer system 20, it should be understood that this communication and all further-described communications may occur using the P2P email system and methods described above.

In some embodiments, emails exchanged on secure email links may be authenticated upon receipt. For example, after creditor computer system 60 communicates a cable bill to debtor computer system 20 in step 204, email client 22 and/or email agent 26 may authenticate the cable bill by, for example, checking a digital certificate enclosed (e.g., attached) with the bill. By authenticating the cable bill, debtor computer system 20 ensures that the bill is from creditor computer system 60 and that the bill may be stored in the appropriate secure folder in step 206. If an email arrives at debtor computer system 20 purporting to be from creditor computer system 60, but the message cannot be authenticated, then email client 22 and/or email agent 26 may discard the message, thereby preventing unsolicited messages.

Email client 22 and/or email agent 26 may be configured to confirm receipt of emails in step 208 to the party who sent the email (e.g., creditor computer system 60). Such confirmation may be communicated using methods described above or other similar means. The same may be true in the reverse situation where debtor computer system 20 sends an email containing, for instance, a payment, to creditor computer system 60. Creditor computer system 60 may be configured to communicate a confirmation receipt back to debtor computer system 20. Using such methods, debtor computer system 20 and/or creditor computer system 60 may track the progress of emails exchanged over secure email links (or any other link, see above).

Referring to FIG. 4C, where an email from creditor computer system 60 to debtor computer system 20 requires a response (e.g., a cable bill requiring payment), debtor computer system 20 may pay the bill directly in step 210. For example, the bill received by debtor computer system 20 in step 204 may have an interface (e.g., a button or link) with which the user of debtor computer system 20 may interact to pay the bill. In contrast to existing systems, debtor computer system 20 may pay the bill without having to remember login credentials for a third party website.

In some embodiments, the bill may contain a link to a third-party payment computer system at which a user of debtor computer system 20 may make a payment. The email client 22 and or email agent 26 may have access to consumer account credentials necessary to log into the third-party payment computer system on behalf of the user. Accordingly, the email client 22 and or email agent 26 may use the consumer account credentials to automatically log the user into the third-party payment computer system without the user having to remember log in information.

The consumer account credentials necessary to log into a creditor computer system's third-party payment computer system may be stored in or in association with the secure folder created for that creditor computer system, so that they are not accessible to those not authorized to access the secure folder. It should be evident, therefore, that in embodiments where a single set of credentials is usable to access all secure folders in an email store, a user need only remember those credentials to be able to access information related to any number of consumer accounts, without having to remember the individual consumer account credentials for each account.

In some embodiments, email client 22 and/or email agent 26 may be configured to allow direct payment without logging in to a third-party website. This may occur at the instruction of the user or even automatically by processing the contents of a received email bill. Just as debtor computer system 20 authenticated the cable bill as described above using credentials enclosed with the cable bill, trusted entities such as creditor computer system 60 similarly may be configured to authenticate messages received from users of P2P email system 10. Such authentication may ensure that a cable bill payment purported to be from debtor computer system 20 is indeed from debtor computer system 20.

As described above, each party communicating over P2P email system 10 may encrypt messages intended for another party by using the other party's public encryption key. Accordingly, debtor computer system 20 may include credit card or other potentially confidential information within her encrypted payment email to creditor computer system 60 without raising security concerns. Intermediate nodes of P2P email system 10 may be used to relay the message, as described above, and they cannot decrypt the message because they lack the private key required for decryption. Only the intended receiver, who necessarily will possess the private key associated with the public key used to encrypt the message, may decrypt the message.

In some embodiments, email client 22 and/or email agent 26 may be configured with a calendar. When a time-sensitive email such as a bill requiring payment is received, email client 22 and/or email agent 26 may be configured to add an entry to the calendar indicating to the user that the bill must be paid, either at the user's request or automatically. Email client 22 and/or email agent 26 further may be configured to automatically pay the bill, either at the instruction of the user, or when a deadline to pay a bill is within a predetermined time period.

Accordingly, while embodiments have been particularly shown and described with reference to the foregoing disclosure, many variations may be made therein. The foregoing embodiments are illustrative, and no single feature or element is essential to all possible combinations that may be used in a particular application. Where the disclosure recites “a” or “a first” element or the equivalent thereof, such disclosure includes one or more such elements, neither requiring nor excluding two or more such elements. Further, ordinal indicators, such as first, second or third, for identified elements are used to distinguish between the elements, and do not indicate or imply a required or limited number of such elements, and do not indicate a particular position or order of such elements unless otherwise specifically stated.

What is claimed is:

1. A method of paying a debt over a network, comprising:
forming a secure email link between a debtor computer system and a creditor computer system;
transmitting a notice of debt from the creditor computer system to the debtor computer system using the secure email link; and
paying at least a portion of the debt at the debtor computer system based upon the notice of debt.

2. The method of claim 1, wherein paying at least a portion of the debt includes transmitting instructions to pay at least a portion of the debt from the debtor computer system directly to the creditor computer system using the secure email link.

3. The method of claim 1, further comprising interacting with an interface on the notice of debt at the debtor computer system to pay at least a portion of the debt.

4. The method of claim 1, further comprising storing the notice of debt in a secure portion of memory of the debtor computer system.

5. The method of claim 4, wherein the secure portion of memory of the debtor computer system is protected with a credential.

6. The method of claim 1, wherein paying at least a portion of the debt includes automatically logging the debtor computer system into a payment computer system to pay the debt without requiring manual entry of a login credential for the payment computer system.

7. The method of claim 6, wherein automatically logging the debtor computer system into the payment computer system to pay the debt includes reading the login credential from a secure portion of memory of the debtor computer system that is protected with a local credential.

8. The method of claim 7, further comprising:
reading a second login credential from a second secure portion of memory of the debtor computer system, the second secure portion of memory being protected with the local credential; and
paying at least a portion of a second debt at the debtor computer system by automatically logging the debtor computer system into a second payment computer system using the second login credential.

9. The method of claim 1, further comprising:
setting a scheduled time to pay the at least a portion of the debt at the debtor computer system;
wherein paying the at least a portion of the debt includes automatically paying the at least a portion of the debt at the scheduled time.

10. A debtor computer system configured to:
form a secure email link with a creditor computer system;
receive a notice of debt from the creditor computer system using the secure email link; and
pay at least a portion of the debt based upon the notice of debt.

11. The debtor computer system of claim 10, further configured to transmit instructions directly to the creditor computer system using the secure email link to pay at least a portion of the debt.

12. The debtor computer system of claim 10, wherein the notice of debt includes an interactive interface to pay at least a portion of the debt.

13. The debtor computer system of claim 10, further configured to store the notice of debt in a secure portion of memory.

14. The debtor computer system of claim 13, wherein the secure portion of memory is protected with a credential.

15. The debtor computer system of claim 10, further configured to automatically log into a payment computer system to pay the debt without requiring manual entry of a login credential for the payment computer system.

16. The debtor computer system of claim 15, further configured to the login credential from a secure portion of memory that is protected with a local credential.

17. The debtor computer system of claim 10, further configured to:
read a second login credential from a second secure portion of memory, the second secure portion of memory being protected with the local credential; and
pay at least a portion of a second debt by automatically logging into a second payment computer system using the second login credential.

18. The debtor computer system of claim 10, further configured to:
set a scheduled time to pay the at least a portion of the debt; and
automatically pay the at least a portion of the debt at the scheduled time.

19. A debtor computer system configured to:
form a secure email link with a creditor computer system over a peer-to-peer email system;
receive a notice of debt from the creditor computer system using the secure email link; and
transmit instructions over the peer-to-peer email system directly to the creditor computer system using the secure email link to pay at least a portion of the debt.

20. The debtor computer system of claim 19, wherein the notice of debt includes an interactive interface to cause the instructions to be transmitted over the peer-to-peer email system directly to the creditor.
